(19) United States
(12) Patent Application Publication
(10) Pub. No.: US 2019/0124086 A1
(43) Pub. Date: Apr. 25, 2019

(54) WEBSITE MONITORING SYSTEM AND MONITORING METHOD

(71) Applicant: MWSTORY Co., Ltd., Seoul (KR)

(72) Inventor: Dae Gull RYU, Seoul (KR)

(21) Appl. No.: 16/306,728

(22) PCT Filed: Sep. 27, 2017
(86) PCT No.: PCT/KR2017/010753

§ 371 Date: Dec. 3, 2018

(30) Foreign Application Priority Data
Dec. 30, 2016 (KR) 10-2016-0184196
Apr. 26, 2017 (KR) 10-2017-0053790

(51) Int. Cl. H04L 29/06; G06F 21/62

(52) U.S. Cl. CPC H04L 63/10; G06F 2221/2141; G06F 21/6218

(57) ABSTRACT

The present invention relates to a website monitoring system. The website monitoring system according to the present invention monitors web information stored in a website using unique authority information having an access right to the website to detect various digital contents such as webtoons, sound sources, videos, and books which are illegally copied and circulated on the website and senses whether the unique authority information is blocked in real time. Further, when the unique authority information is blocked, the website monitoring system resumes the monitoring on the web information using the other unique authority information except the blocked unique authority information.

### TECHNICAL FIELD

The present invention relates to a website monitoring system, and more particularly, to a website monitoring system and a monitoring method which monitor web information stored in a website using unique authority information having an access right to the website, senses whether the unique authority information is blocked in real time, and when the unique authority information is blocked, resumes the monitoring for the web information using the other unique authority information excluding the blocked unique authority information.

### BACKGROUND ART

With the advent of the information society, various digital contents such as webtoons, sound sources, videos and books are freely distributed and circulated through information providing media such as websites. Therefore, the digital contents may be shared by anyone anywhere in the world. In the meantime, as compared with rapid spread of the digital contents, user's recognition for protection of copyright of the digital contents is far from enough. Therefore, in order to overcome the problem, website monitoring to detect illegal distribution of digital contents is considered as an important means in the information society.

A method for protecting the copyright of the digital contents may be divided into a proactive measure which makes it difficult to copy, distribute, and circulate the copyright work and a post-measure which detects and cracks down the copyright work which is illegally copied, distributed, and circulated.

The proactive measure has been technologically developed in many ways such as a watermarking technique which prevents the copy or limits the number of copies. However, the methods based on the proactive measures have been largely ineffective due to the development of technologies which arbitrarily release the restrictions. Further, the proactive measures prohibit copy which does not correspond to the direct infringement of the copyright work so that the actual application thereof is frequently insignificant.

Therefore, in order to restrict illegal copy, circulation, and distribution of the digital contents, it is necessary to consistently monitor the websites using the post-measures and expose the illegal circulation of the digital contents at the same time.

However, the digital contents which are currently illegally circulated are detected mainly by a manual task of copyright holders or consignment organizations which manage the copyright in trust that voluntarily access the website and detect the illegally circulated digital contents. According to this method, it is very difficult to monitor and detect multitudinous websites. Further, even though the websites are detected, when a new copyright infringement case is added to the detected websites, the consistent monitoring may become useless unless reconnection and redetection are not performed.

Specifically, websites to be managed consistently expose the digital contents which are illegally circulated by blocking specific information such as IP or ID of a website monitoring server.

In the related art, as disclosed in Patent Document 1, the monitoring of digital contents which are illegally shared is performed. However, Patent Document 1 has not addressed the measures against the blocking the monitoring of the website server. Patent Document 1: Korean Registered Patent Publication No. 10-1634754 (published on Jul. 22, 2016).

### DISCLOSURE

### Technical Problem

A technical object to be achieved by the present invention is to provide a website monitoring system and a monitoring method which sense the blocking of access to the web information monitoring from the website to resume the monitoring after resetting unique authority information having an access authority to consistently monitor the illegally copied digital contents.

Another technical object to be achieved by the present invention is to provide a website monitoring system and a monitoring method which prevent unique authority information from being discarded by reusing the blocked unique authority information depending on whether to update the blocked state of the unique authority information even when the unique authority information is blocked.

### Technical Solution

In order to achieve the above-described technical object, a website monitoring system according to the present invention includes a website and a monitoring server.

Web information is stored in the website. The monitoring server monitors whether the web information is illegally copied web information using at least one unique authority information among a plurality of unique authority information having an access right to the website, senses whether the unique authority information is blocked from the website, and resumes the monitoring of the web information using other unique authority information except the blocked unique authority information when the unique authority information is blocked from the website. Further, when the unique authority information is blocked from the website, the monitoring server automatically substitutes other unique authority information into script information which issues an access command to monitor the website.

According to another aspect of the present invention, a website monitoring method includes a web information monitoring step, a monitoring blocking sensing step, a monitoring resetting step, and a monitoring resuming step.

In the web information monitoring step, the monitoring server monitors whether web information is illegally copied web information using at least one unique authority information among a plurality of unique authority information having an access right to a website in which a plurality of web information is stored. In the monitoring blocking sensing step, the monitoring server senses whether the unique authority information is blocked from the website when the monitoring server monitors whether the web information is illegally copied web information. In the monitoring resetting step, when the unique authority information is blocked from the website, the monitor server resets the monitoring for the website using other unique authority information except the blocked unique authority information. In the monitoring resuming step, the monitoring server resumes the monitoring of the website using the other unique authority information. Further, in the monitoring resetting step, the monitoring server automatically substitutes other unique authority information into script information which issues an access command to monitor the website.

### Advantageous Effects

According to the present invention, a website monitoring system and a monitoring method may sense that access to the web information monitoring is blocked from the website to resume the monitoring after resetting unique authority information having an access authority, thereby consistently monitoring the illegally copied digital contents.

Further, according to the present invention, a website monitoring system and a monitoring method which prevent unique authority information from being discarded by reusing the blocked unique authority information depending on whether to update the blocked state of the unique authority information even when the unique authority information is blocked.

### DESCRIPTION OF DRAWINGS

FIG. 1 is a block diagram illustrating a configuration of a website monitoring system according to the present invention.

FIG. 2 is a block diagram illustrating a configuration of a server illustrated in FIG. 1.

FIG. 3 is a view illustrating a blocking mapping table illustrated in FIG. 2.

FIG. 4 is a flowchart illustrating a processing procedure of a website monitoring method according to the present invention.

### BEST MODE

Embodiments of the present invention may be modified in various forms, and the scope of the present invention is not interpreted as being limited to the exemplary embodiments described below. The embodiments are provided for more completely explaining the present invention to those skilled in the art. Therefore, the shapes of the components in the drawings are drawn to emphasize a clearer explanation.

Hereinafter, embodiments of the present invention will be described in detail with reference to the accompanying drawings.

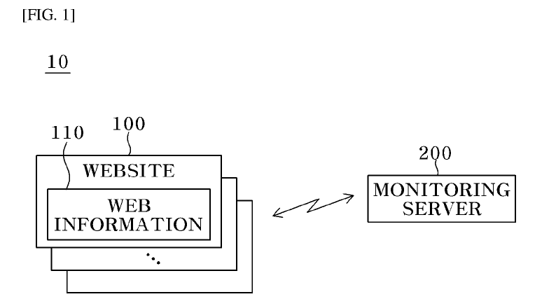

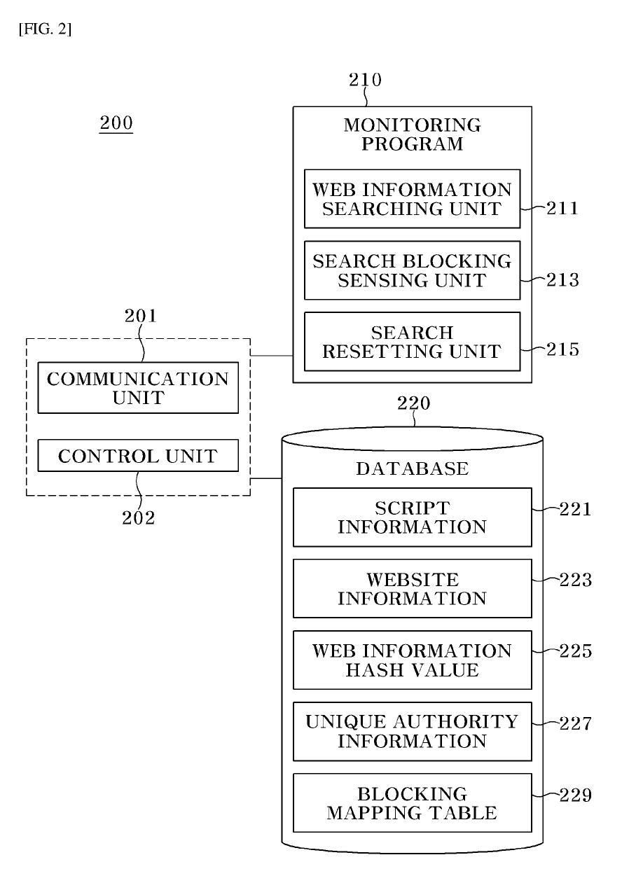

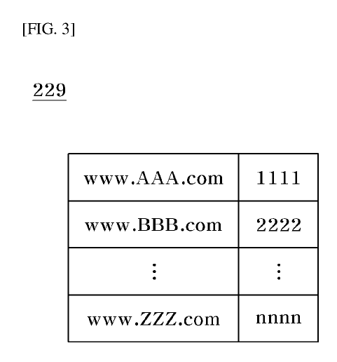

FIG. 1 is a block diagram illustrating a configuration of a website monitoring system according to the present invention. FIG. 2 is a block diagram illustrating a configuration of a server illustrated in FIG. 1. FIG. 3 is a view illustrating a blocking mapping table illustrated in FIG. 2.

Referring to FIGS. 1 to 3, in order to detect various digital contents such as webtoons, sound sources, videos, and books which are illegally copied and circulated on a website 100, a website monitoring system 10 according to the present invention monitors web information 110 stored in the website 100 using a monitoring server 200 and senses whether the monitoring is blocked in real time. Further, when the monitoring for the website 100 is blocked, the website monitoring system 10 resumes monitoring of the website 100 using the other unique authority information 227 except at least one unique authority information 227 having an access right to the website 100. That is, even though the unique authority information 227 is blocked from the website 100, the website monitoring system 10 according to the present invention may consistently monitor the website 100, that is, web information 110, using other unique authority information 227. In such a website monitoring system 10, the website 100 and a monitoring server 200 may be connected to each other through a communication path such as a communication network.

Specifically, the website 100 stores web information 110 including various digital contents such as webtoons, sound sources, videos, and books. Further, the website 100 approves the unique authority information 227 having an access authority to the website 100 to detect web information 110 which approves the monitoring. In this case, the websites 100 are scattered in various places without discriminating the places so that it is assumed that the web information 110 may be uploaded by individual website managers. Specifically, the web information 110 includes identifiable attribute information such as a tag so that when the monitoring is performed by the monitoring server 200, the attribute information may be provided.

The monitoring server 200 monitors whether the web information 110 is illegally copied web information using at least one unique authority information 227 among a plurality of unique authority information 227 having an access right to the website 100 and senses whether the unique authority information 227 is blocked from the website 100. Further, when the unique authority information 227 is blocked from the website 100, the monitoring server 200 resumes the monitoring of the web information 110 using the other unique authority information 227 except the blocked unique authority information 227. Such a monitoring server 200 includes a control unit 201, a communication unit 202, a monitoring program 210, and a database 220.

The control unit 201 controls an overall operation of the monitoring server 200 to be processed using the monitoring program 210. That is, the control unit 201 controls the communication unit 202, the monitoring program 210, and the database 220.

The communication unit 202 connects the website 100 and the monitoring serer 200 to each other through a communication path such as a communication network. Further, the communication unit 202 is controlled by the control unit 201 to perform data communication between the website 100 and the monitoring server 200.

The monitoring program 210 monitors whether the web information 110 is illegally copied web information using at least one unique authority information 227 among a plurality of unique authority information 227 having an access right to the website 100 to sense whether the web information 110 is illegally copied web information in real time. Further, when the unique authority information 227 is blocked from the website 100 during the monitoring, the monitoring program 210 stores a blocking mapping table in which the blocked unique authority information 227 and the website 100 which blocks the unique authority information 227 are mapped to each other. Further, the monitoring program 210 resets the monitoring using other unique authority information 227 instead of the blocked unique authority information 227 to resume the monitoring of the website 100. In this case, the monitoring program 210 substitutes another unique authority information 227 into script information 221 which issues an access command to perform the monitoring on the website 100, that is, the command to allow the access to the website 100. Further, the monitoring program may be equipped as a computer program which performs a searching and indexing function, such as a crawler. Further, when the other unique authority information 227 is blocked by the web site 100 which blocks the unique authority information 227 again, the monitoring program 210 extracts the unique authority information 227 corresponding to the website 100 which blocks the unique authority information 227 from the blocking mapping table 229 and resumes the monitoring of the website 100 which blocks the unique authority information 227 using the extracted unique authority information 227 depending whether the extracted unique authority information 227 is unblocked. To this end, the monitoring program 210 includes a web information searching unit 211, a search blocking sensing unit 213, and a search resetting unit 215.

The web information searching unit 211 is equipped as a computer program such as a crawler and monitors whether the web information 110 is illegally copied web information using at least one unique authority information 227 among a plurality of unique authority information 227 having an access right to the website 100 to sense whether the web information 110 is illegally copied web information in real time.

The search blocking sensing unit 213 senses whether the unique authority information 227 is blocked from the website 100 while the monitoring is performed by the web information searching unit 211. Further, when the unique authority information 227 is blocked from the website 100, the search blocking sensing unit 213 stores the unique authority information 227 blocked from the website 100 and a website 100 which blocks the unique authority information 227 in the database 220. Further, the search blocking sensing unit 213 transmits a signal indicating that the monitoring is blocked from the website 100 to the search resetting unit 215.

The search resetting unit 215 receives the signal indicating that the monitoring, that is, the access to the unique authority information 227 is blocked, from the search blocking sensing unit 213 to reset the monitoring by substituting other unique authority information 227 except the blocked unique authority information 227 into script information 221, thereby resuming the monitoring of the website 100 which blocks the unique authority information 227.

The database 220 stores script information 221, website information 223, a web information hash value 225, and unique authority information 227 from a manager of the monitoring server 200 under the control of the control unit 201 and receives the blocked unique authority information 227 and the website 100 which blocks the unique authority information 227 which is from the search blocking sensing unit 213 to store them in the blocking mapping table 229. Here, the website information 223 may include location records such as a uniform resource locator (URL) through which the web site 100 is searched. That is, when the web information searching unit 211 and the search resetting unit 215 try to access the website 100, the website information 223 provides location records to provide information which allows the access to the website 100 to be monitored. Further, the unique authority information 227 may be included as identification information having an access authority to the website 100, such as an internet protocol (IP) and an identification (ID) which is approved to access the website 100. Further, a plurality of unique authority information is provided so as to correspond to the blocking of at least one unique authority information 227 from the website 100. Further, the web information hash value 225 is a password for discerning an illegally copied web information 110 from the web information 110 and is provided to the web information searching unit 211 to verify identity of the web information 110. Referring to FIG. 3, specifically, the blocking mapping table 229 may allow the blocked unique authority information 227 and the web site 100 which blocks the unique authority information 227 to correspond one to one to each other. Although one to one correspondence is illustrated in the drawing, it is obvious that when one website 100 overlaps for a plurality of blocked unique authority information 227, multiple-to-one correspondence is allowed therebetween.

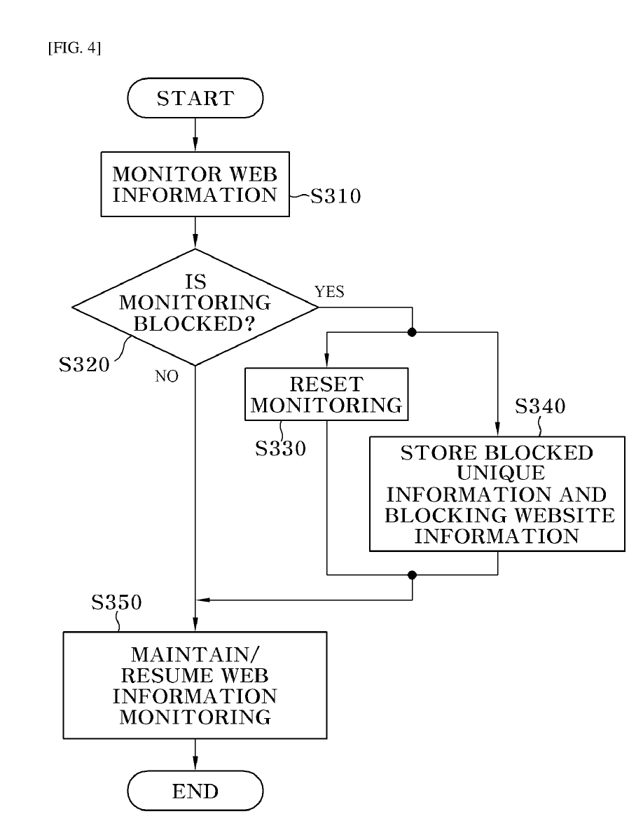

Specifically, a website monitoring method according to an embodiment of the present invention will be described in detail with reference to FIG. 4.

FIG. 4 is a flowchart illustrating a processing procedure of a website monitoring method according to the present invention. Here, the website monitoring method will be described in detail using components of the website monitoring system 10 illustrated in FIGS. 1 to 3.

Referring to FIG. 4, according to the website monitoring method according to the embodiment of the present invention, in step S310, the monitoring server 200 accesses the website 100 using at least one unique authority information 227 among a plurality of unique authority information and monitors the website 100 to detect illegally copied web information which is illegally copied and circulated, among web information 110 stored in the accessed website 100.

In step S320, the monitoring server 200 senses whether the unique authority information 227 is blocked from the accessed website 100 in real time. When the unique authority information 227 is blocked from the website 100, this procedure goes to steps S330 and S340 and when the unique authority information is not blocked from the website 100, this procedure goes to step S350 to consistently monitor the website 100.

In step s330, the monitoring server 200 substitutes other unique authority information 227 except the unique authority information 227 blocked from the website 100 into the script information 221 to reset to resume the monitoring of the website 100.

Further, in step S340, the monitoring server 200 generates a blocking mapping table 229 by mapping the unique authority information 227 blocked from the website 100 and the website 100 which blocks the unique authority information 227 to form a one-to-one correspondence or multiple-to-one correspondence or updates the previously stored blocking mapping table 229. In this case, when the other unique authority information 227 is blocked from the website 100 which blocks the unique authority information 227 while consistently monitoring the website 100 in step S350, the monitoring server 200 extracts unique authority information 227 corresponding to the website 100 which blocks the unique authority information 227 from the blocking mapping table 229 and resumes the monitoring of the website 100 which blocks the unique authority information 227 using the extracted unique authority information 227 depending on whether the extracted unique authority information 227 is unblocked. Here, it is understood that step S330 is repeatedly performed to resume the monitoring of the website 100 which blocks the unique authority information 227 using the extracted unique authority information 227.

That is, the web information monitoring step is performed in step S310, the monitoring blocking detecting step is performed in step S320, and the monitoring resetting step is performed in steps S330 and S340. Further, in step S350, the monitoring resuming step is performed.

Accordingly, the website monitoring system 10 according to the present invention monitors the web information 110 stored in the website 100 using unique authority information 227 having an access right to the website 100 and senses whether the unique authority information 227 is blocked in real time in order to detect various digital contents such as webtoons, sound sources, videos, and books which are illegally copied and circulated on a website 100. Further, when the unique authority information 227 is blocked, the website monitoring system 10 resumes the monitoring of the web information 110 using the other unique authority information 227 except the blocked unique authority information 227.

Although a configuration and an operation of the website monitoring system and the monitoring method according to the present invention have been described with reference to the detailed description and the drawings, this merely describes the embodiments and various modification and changes may be allowed without departing from the technical spirit of the present invention.

1. A website monitoring system, comprising:
a website in which web information is stored; and
a monitoring server which monitors whether the web information is illegally copied web information using at least one unique authority information among a plurality of unique authority information having an access right to the website, senses whether the unique authority information is blocked from the website, and resumes the monitoring of the web information using the other unique authority information except the blocked unique authority information when the unique authority information is blocked from the website,
wherein when the unique authority information is blocked from the website, the monitoring server automatically substitutes other unique authority information into script information which issues an access command to monitor the website.

2. The website monitoring system of claim 1, wherein the monitoring server stores a blocking mapping table in which the unique authority information blocked from the website and the website which blocks the unique authority information are mapped to each other, when the other unique authority information is blocked from the website which blocks the unique authority information, extracts the unique authority information corresponding to the website which blocks the unique authority information from the blocking mapping table, and resumes the monitoring of the website which blocks the unique authority information using the extracted unique authority information depending on whether the extracted unique authority information is unblocked.

3. A website monitoring method, comprising:
a web information monitoring step of monitoring whether web information is illegally copied web information using at least one unique authority information among a plurality of unique authority information having an access right to a website in which a plurality of web information is stored, by a monitoring server;
a monitoring blocking sensing step of sensing whether the unique authority information is blocked from the website when the monitoring server monitors whether the web information is illegally copied web information;
a monitoring resetting step of resetting the monitoring for the website using other unique authority information except the blocked unique authority information, by the monitoring server, when the unique authority information is blocked from the website; and
a monitoring resuming step of resuming the monitoring for the website using the other unique authority information, by the monitoring server,
wherein in the monitoring resetting step, the monitoring server automatically substitutes the other unique authority information into script information which issues an access command to monitor the website.

4. The website monitoring method of claim 3, wherein in the monitoring resetting step, when the other unique authority information is blocked from the website which blocks the unique authority information, the monitoring server which stores a blocking mapping table in which the unique authority information blocked from the website and the website which blocks the unique authority information are mapped to each other extracts the unique authority information corresponding to the website which blocks the unique authority information from the blocking mapping table, and resets to resume the monitoring of the website which blocks the unique authority information using the extracted unique authority information depending on whether the extracted unique authority information is unblocked.
